(19) United States
(12) Patent Application Publication
(10) Pub. No.: US 2007/0071508 A1
(43) Pub. Date: Mar. 29, 2007

(54) Developing roller comprising pigment having opposite polarity to toner and method for manufacturing the same

(75) Inventor: Hee-won Jung, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/496,519

(22) Filed: Aug. 1, 2006

(30) Foreign Application Priority Data
Sep. 23, 2005 (KR) 2005-88944

(51) Int. Cl. G03G 15/08

(52) U.S. Cl. 399/286

(57) ABSTRACT

A developing roller for an electrophotographic image forming device and a method for manufacturing the same, the developing roller may include a central shaft and a roller body, the roller body may be made of a rubber-based elastic material, and the roller body may include a pigment having an opposite polarity to a toner used in the electrophotographic image forming device. The developing roller does not cause degradation of a frictional charging capability of the toner, and thus prevents contamination in a non-image zone of the developing roller.

### CROSS-REFERENCE TO RELATED APPLICATIONS

This application claims priority under 35 U.S.C. § 119 from Korean Patent Application No. 2005-88944 filed on September 23 in the Korean Intellectual Property Office, the entire content of which is incorporated herein by reference.

### BACKGROUND OF THE INVENTION

1. Field of the Invention

The present general inventive concept relates to a developing roller. More particularly, the present general inventive concept relates to a developing roller for an electrophotographic image forming device, which prevents a drop in electric adsorption to a toner, caused by frictional charging of the toner, maintains heat resistance and durability, and realizes various colors.

2. Description of the Related Art

Electrophotographic devices include copying machines, printers, facsimiles, and all-in-one imaging machines. FIG. 1 is a schematic view illustrating a conventional electrophotographic printer among the above electrophotographic devices. Hereafter, an operational mechanism of the conventional electrophotographic printer will be explained with reference to FIG. 1. A toner stored in a toner storage section is agitated electrically and homogeneously by an agitator, and the agitated toner is attached to a developing roller 200 having a predetermined voltage provided by mechanical and electrical forces of a feed roller 300.

Meanwhile, while a charging roller 100 is rotated along with a photoreceptor 400, the charge roller 100 causes a surface of the photoreceptor 400 to be charged uniformly under a high voltage. An exposure unit (e.g., a laser scanning unit (LSU)) irradiates laser beams to the surface of the photoreceptor 400, charged with the uniform voltage, to form an electrostatic latent image on the surface of the photoreceptor. The toner, which is attached uniformly to a surface of the developing roller 200 in the form of a thin film, is adhered to the electrostatic latent image, thereby forming a toner image. Then, the toner image is transferred to a recording medium by means of a transfer roller (not illustrated).

The toner currently used in conventional electrophotographic image forming devices, such as the above-discussed conventional electrophotographic printer, is a non-magnetic one-part toner, which is attached to the surface of a developing roller electrostatically by a frictional charging mechanism.

The developing roller includes a roller body, and a metallic central shaft inserted into the roller body.

In general, the roller body of the developing roller is made of a semi-conductive rubber-based material. Additionally, the conventional developing roller is manufactured by adding conductive carbon black to the roller body, in order to cover stains or defects present on the surface of the developing roller or inside the developing roller caused by contaminants during its manufacturing process.

However, due to the carbon black added to the developing roller, charging characteristics of the developing roller are degraded and a toner charging capability is degraded accordingly. Therefore, conventional developing rollers using carbon black in the roller body suffer from a so-called background phenomenon, which arises in a non-image zone of the conventional developing rollers as a result of the carbon black added to the roller body.

### SUMMARY OF THE INVENTION

The present general inventive concept provides a developing roller for an electrophotographic image forming device, which prevents degradation of a toner charging capability so as to prevent contamination in a non-image zone, and realizes various colors to be applied in an electrophotographic process.

The present general inventive concept also provides a method for manufacturing a developing roller for an electrophotographic image forming device, wherein the developing roller prevents degradation of a toner charging capability so as to prevent contamination in a non-image zone, and realizes various colors to be applied in an electrophotographic process.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a developing roller useable with an electrophotographic image forming device using a toner to form an image, the developing roller including a central shaft and roller body comprising a rubber-based elastic material and a pigment having an opposite polarity to the toner.

The pigment may be in an amount of about 0.5 to about 30 parts by weight based on 100 parts by weight of the rubber-based elastic material.

The rubber-based elastic material may include at least one rubber selected from the group consisting of nitrile-butadiene rubber, epichlorohydrin rubber, chloroprene rubber, styrene-butadiene rubber, chlorosulfonated polyethylene rubber, and ethylene-propylene-diene terpolymer rubber.

The pigment may include at least one compound selected from the group consisting of: colorless inorganic pigments including white inorganic pigments such as ZnO, TiO₂, lithopone (ZnS+BaSO₄) and 2PbCO₃.Pb[OH]₂, and black inorganic pigments such as FeO.FeO₃; colored inorganic pigments including yellow inorganic pigments such as PbCrO₄, FeO[OH], Fe₂O₃.H₂O, CdS, a mixed pigment of CdS with ZnS and TiO₂.NiO.Sb₂O₃, orange inorganic pigments such as PbCrO₄.PbO and PbCrO₄.PbMoO₄.PbSO₄, red inorganic pigments such as Fe₂O₃, Pb₃O₄ and a mixed pigment of CdS with CdSe, purple inorganic pigments such as NH₄MnP₂O₇, blue inorganic pigments such as Fe[NH₄]Fe[CN]₆.xH₂O, Na_{6˜8}Al₆Si₆O₂₄S_{2˜4} and CoO.Al₂O₃, and green inorganic pigments such as Cu[CH₃CO₂]₂.3Cu[AsO₂]₂; and colored organic pigments including phthalocyanine pigments and diazo-based pigments.

The roller body may further include a filler.

The filler may include at least one compound selected from the group consisting of CaCO₃, MgSiO₃, and Al₂(SiO₃)₄.

The foregoing and/or other aspects and utilities of the present general inventive concept may also be achieved by providing a method of manufacturing a developing roller useable with an electrophotographic image forming device, the method including blending a rubber-based elastic material, pigment and a filler, aging and extruding the resultant blend, adding a crosslinking agent to the blend and curing the blend, and cutting and processing the cured blend, in which the pigment includes at least one compound selected from the group consisting of: colorless inorganic pigments including white inorganic pigments such as ZnO, TiO₂, lithopone (ZnS+BaSO₄) and 2PbCO₃.Pb[OH]₂, and black inorganic pigments such as FeO.FeO₃; colored inorganic pigments including yellow inorganic pigments such as PbCrO₄, FeO[OH], Fe₂O₃.H₂O, CdS, a mixed pigment of CdS with ZnS and TiO₂.NiO.Sb₂O₃, orange inorganic pigments such as PbCrO₄.PbO and PbCrO₄.PbMoO₄.PbSO₄, red inorganic pigments such as Fe₂O₃, Pb₃O₄ and a mixed pigment of CdS with CdSe, purple inorganic pigments such as NH₄MnP₂O₇, blue inorganic pigments such as Fe[NH₄]Fe[CN]₆.xH₂O, Na_{6˜8}Al₆Si₆O₂₄S_{2˜4} and CoO.Al₂O₃, and green inorganic pigments such as Cu[CH₃CO₂]₂.3Cu[AsO₂]₂; and colored organic pigments including phthalocyanine pigments and diazo-based pigments.

The filler may include at least one compound selected from the group consisting of CaCO₃, MgSiO₃, and Al₂(SiO₃)₄.

The rubber-based elastic material may include at least one rubber selected from the group consisting of nitrile-butadiene rubber, epichlorohydrin rubber, chloroprene rubber, styrene-butadiene rubber, chlorosulfonated polyethylene rubber, and ethylene-propylene-diene terpolymer rubber. The rubber-based elastic material may be used alone or in combination.

The pigment may be used in an amount of about 0.5 to about 30 parts by weight based on 100 parts by weight of the rubber-based elastic material.

The foregoing and/or other aspects and utilities of the present general inventive concept may also be achieved by providing a method of manufacturing a developing roller useable with an electrophotographic image forming device, the method including blending a rubber-based elastic material and a filler, aging and extruding the blend, adding a crosslinking agent to the blend and curing the blend, mixing a pigment with a binder resin to form a pigment dispersion, coating the cured blend with the pigment dispersion, and cutting and processing the coated blend, in which the pigment comprises at least one compound selected from the group consisting of: colorless inorganic pigments including white inorganic pigments such as ZnO, TiO₂, lithopone (ZnS+BaSO₄) and 2PbCO₃.Pb[OH]₂, and black inorganic pigments such as FeO.FeO₃; colored inorganic pigments including yellow inorganic pigments such as PbCrO₄, FeO[OH], Fe₂O₃.H₂O, CdS, a mixed pigment of CdS with ZnS and TiO₂.NiO.Sb₂O₃, orange inorganic pigments such as PbCrO₄.PbO and PbCrO₄.PbMoO₄.PbSO₄, red inorganic pigments such as Fe₂O₃, Pb₃O₄ and a mixed pigment of CdS with CdSe, purple inorganic pigments such as NH₄MnP₂O₇, blue inorganic pigments such as Fe[NH₄]Fe[CN]₆.xH₂O, Na_{6˜8}Al₆Si₆O₂₄S_{2˜4} and CoO.Al₂O₃, and green inorganic pigments such as Cu[CH₃CO₂]₂.3Cu[AsO₂]₂; and colored organic pigments including phthalocyanine pigments and diazo-based pigments.

The filler may include at least one compound selected from the group consisting of CaCO₃, MgSiO₃, and Al₂(SiO₃)₄.

The rubber-based elastic material may include at least one rubber selected from the group consisting of nitrile-butadiene rubber, epichlorohydrin rubber, chloroprene rubber, styrene-butadiene rubber, chlorosulfonated polyethylene rubber, and ethylene-propylene-diene terpolymer rubber.

The pigment may be used in an amount of about 0.5 to about 30 parts by weight based on 100 parts by weight of the rubber-based elastic material.

The foregoing and/or other aspects and utilities of the present general inventive concept may also be achieved by providing an electrophotographic imaging device cartridge, including a toner unit comprising toner that includes a colorant having a first polarity, and a developing roller comprising a shaft and a body comprising a rubber-based material and at least one colorant having a second polarity that is different from the first polarity. The body may include a surface coating comprising a dispersion of the at least one colorant and a binder resin. The body may include a uniform dispersion of the rubber-based material and the at least one colorant. A JIS-A hardness of the developing roller may be in a range of about 20 degrees to about 55 degrees. A JIS-A hardness of the developing roller is in a range of about 50 to about 54 degrees. In embodiments, the at least one colorant is not carbon black. A weight ratio of the at least one colorant to the rubber-based material may be about 0.5:100 to about 30:100.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a conventional electrophotographic printer;

FIG. 2A is a schematic view illustrating a developing roller according to an embodiment of the present general inventive concept; and

FIG. 2B is a sectional view illustrating the developing roller in FIG. 2A.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

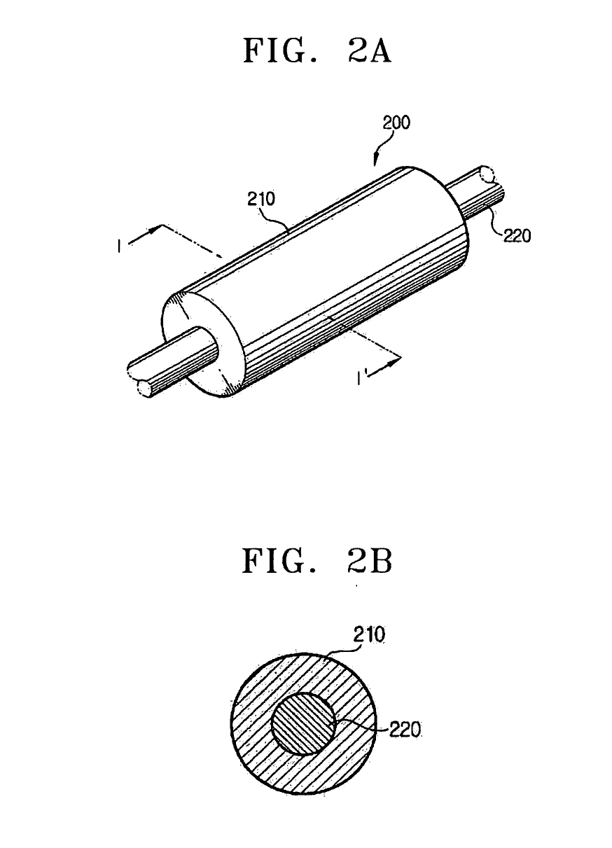

A developing roller 200 according to an embodiment of the present general inventive concept may include a central shaft 220 and a roller body 210. The roller body may be made of, for example, a rubber-based elastic material, as illustrated in FIGS. 2A and 2B.

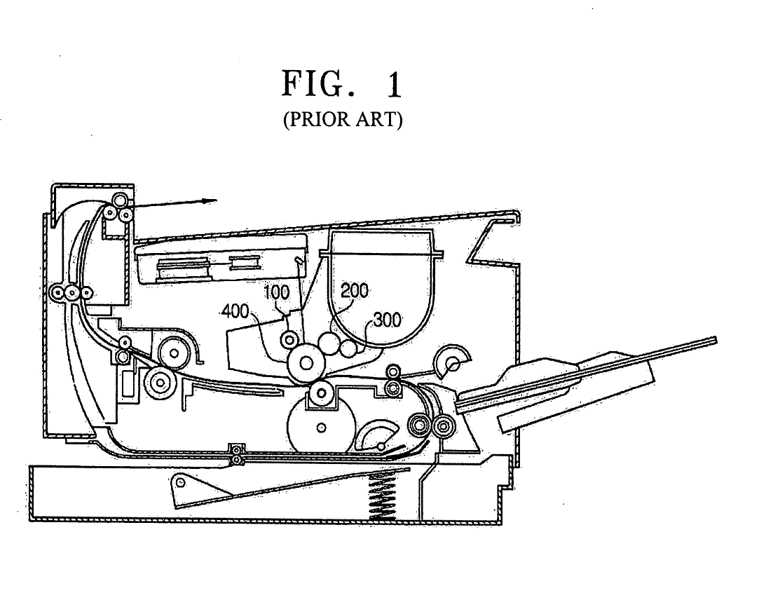

The developing roller 200 may be used in an electrophotographic image forming device as shown in FIG. 1, and FIG. 2B is a sectional view of the developing roller 200 taken along lines I-I′ of FIG. 2A.

The rubber-based elastic material may be at least one rubber selected from the group consisting of nitrile-butadiene rubber, epichlorohydrin rubber, chloroprene rubber, styrene-butadiene rubber, chlorosulfonated polyethylene rubber, and ethylene-propylene-diene terpolymer rubber. However, the scope of the present general inventive concept is not limited to these specific rubbers, and the rubber-based elastic material may be any rubber-based elastic material suitable for use in the roller body.

The roller body according to an embodiment of the present general inventive concept may include the rubber-based elastic material as a base material, and may further include a pigment having an opposite polarity to a toner.

The toner may be a colorant for realizing a color. In general, a conventional electrophotographic image forming device uses a pigment-based colorant. Particularly, carbon black is widely used in order to realize a black color of a toner. Although carbon black is added to a roller body of a conventional developing roller in order to cover stains or defects of the developing roller, carbon black causes the above-mentioned problem in that a frictional charging capability of the toner is degraded due to the conductivity of carbon black. Because of the above-mentioned problem, it is difficult to form a desired image in conventional electrophotographic image forming devices. Thus, according to an embodiment of the present general inventive concept, a roller body of a developing roller may include a pigment having an opposite polarity to a pigment used in the toner to prevent degradation of a frictional charging capability of the toner.

The pigment that may be added to the developing roller according to the present general inventive concept may be at least one pigment selected from the group consisting of: colorless inorganic pigments (including white inorganic pigments, such as ZnO, TiO₂, lithopone (ZnS+BaSO₄) and 2PbCO₃.Pb[OH]₂, and black inorganic pigments such, as FeO.FeO₃), colored inorganic pigments (including yellow inorganic pigments, such as PbCrO₄, FeO[OH], Fe₂O₃.H₂O, CdS, a mixed pigment of CdS with ZnS, and TiO₂.NiO.Sb₂O₃, orange inorganic pigments, such as PbCrO₄.PbO and PbCrO₄.PbMoO₄.PbSO₄, red inorganic pigments, such as Fe₂O₃, Pb₃O₄ and a mixed pigment of CdS with CdSe, purple inorganic pigments, such as NH₄MnP₂O₇, blue inorganic pigments, such as Fe[NH₄]Fe[CN]₆.xH₂O, Na_{6˜8}Al₆Si₆O₂₄S_{2˜4} and CoO.Al₂O₃, and green inorganic pigments, such as Cu[CH₃CO₂]₂.3Cu[AsO₂]₂), and colored organic pigments (including phthalocyanine pigments and diazo-based pigments). However, the scope of the present general inventive concept is not limited these specific pigments, and other suitable pigments may be used. In particular, the pigment may be selected based on the toner used in the electrophotographic image forming device, to which the developing roller is applied.

The pigment may be present in the developing roller in an amount of about 0.5 to about 30 parts by weight based on 100 parts by weight of the rubber-based elastic material. For example, the pigment may be present in the developing roller in an amount of about 0.5 to about 1 part by weight, about 0.5 to about 5 parts, about 1 to about 10 parts, about 10 to about 30 parts, or about 20 to about 30 parts, based on 100 parts by weight of the rubber-based elastic material. When the pigment is used in an amount of less than about 0.5 parts by weight, it is not possible to obtain desired physical properties from the pigment. On the other hand, when the pigment is used in an amount of greater than about 30 parts by weight, a size of the roller body must be increased, the developing roller must have an undesirably-increased hardness, and a cost of manufacturing the developing roller increases.

In addition, the pigment may be present in the developing roller at a weight ratio of about 0.5:100 to about 30:100 of the pigment to the rubber-based elastic material. For example, the pigment may be present in the developing roller at a weight ratio of about 1:100, about 5:100, about 10:100, or about 20:100, of the pigment to the rubber-based elastic material. When the pigment is used at a weight ratio of less than about 0.5:100 of the pigment to the rubber-based elastic material, it is not possible to obtain desired physical properties from the pigment. On the other hand, when the pigment is used at a weight ratio of greater than about 30:100 of the pigment to the rubber-based elastic material, a size of the roller body must be increased, the developing roller must have an undesirably-increased hardness, and a cost of manufacturing the developing roller increases.

A desired elasticity is obtained in a developing roller having a JIS-A hardness range of about 20 to about 55 degrees. If the harness is less than about 20 degrees, dimensional precision cannot be maintained and an image noise arises. On the other hand, if the harness is greater than about 55 degrees, a toner is subjected to severe stress, thereby generating toner microparticles and causing an undesirable so-called filming phenomenon in the roller. As used herein, JIS-A is referred to as the Japan Industrial Standard.

The roller body of the developing roller may further include a filler. The filler may be added to help mold the rubber-based elastic material into a desired shape, and to maintain the shape. For example, the filler may help by solving the problem of a high viscosity of the rubber during the molding of the rubber-based elastic material, by minimizing heat shrinkage of the rubber-based elastic material, and by reducing thermal expansion, so as to minimize deformation of the rubber. The filler may be at least one compound selected from the group consisting of CaCO₃, MgSiO₃, and Al₂(SiO₃)₄. However, the filler is not limited to these specific compounds, and can be one or more other suitable fillers.

A method of making a developing roller according to an embodiment of the present general inventive concept will now be described.

Raw materials may first be weighed, and the weighed raw materials may be preliminarily blended and mixed by using an open roller capable of mechanical mixing, such as a kneader, an extruder, a banbury mixer, and the like.

The raw materials may include a rubber-based elastic material as a base material for the roller body, along with a pigment and/or a filler. Moreover, it is possible to include in the raw materials one or more additives suitable for use in the developing roller. For example, the raw materials may also include one or more of anti-clogging agents, polymeric additives, anti-kogation additives, anti-curl agents, humectants, biocides, anti-bleed agents, color-bleeding additives, and pH buffering agents.

To recover an entangled structural array formed upon blending, the blend of raw materials may be aged at room temperature for a predetermined time.

The blend may be extruded by a single extruder or twin extruder at a low temperature in order to minimize effects of a high viscosity of the rubber and thermal damages that may be caused by the additives.

Then, a crosslinking agent may be added to the extruded blend, along with an optional crosslinking accelerator.

The crosslinking agent added to the blend may be decomposed by heating, so as to form a three-dimensional network structure and to impart elasticity. The blend may then be cured. Optionally, decomposition of the crosslinking agent may be performed by heating with or without pressure.

Next, the cured blend may be cut into a desired size and then processed, while controlling an outer diameter and a surface roughness, to provide a developing roller according to an embodiment of the present general inventive concept.

Alternatively, the rubber-based material, the filler, and the one or more additives are weighed and blended in a first step. The blend is then aged, extruded, heated, and cured. Subsequently, the cured blend may be coated with a pigment dispersion prepared separately to provide a developing roller according to an embodiment of the present general inventive concept.

When the pigment is added to the raw materials to be blended with the raw materials, the pigment can be dispersed uniformly into the roller body as well as on the roller surface. On the other hand, when a developing roller is formed by coating the surface of the roller body with a pigment dispersion, the pigment is dispersed in a binder resin and coated only on the roller surface, and not into the roller body itself.

The present general inventive concept will be explained in more detail with reference to the following Examples and Comparative Examples.

### EXAMPLE 1

100 parts by weight of a nitrile butadiene rubber, 5 parts by weight of a diazo yellow pigment, and 5 parts by weight of CaCO3 were blended and dispersed homogeneously using a kneader, followed by aging of the blend at room temperature. Then, the blend was subjected to a low-temperature extrusion using a twin extruder. A crosslinking agent was added to the extrusion and was cured by heating to provide a roller body.

Next, the roller body prepared as described above was attached to a shaft made of iron electroless-plated with nickel and having a diameter of 8 mm and length of 228 mm to provide a developing roller. The developing roller had a hardness (JIS-A) of about 54°.

### EXAMPLE 2

100 parts by weight of a nitrile butadiene rubber, 5 parts by weight of a phthalocyanine blue pigment, and 5 parts by weight of CaCO₃ were blended and dispersed homogeneously using a kneader, followed by aging of the blend at room temperature. Then, the blend was subjected to low-temperature extrusion using a twin extruder. A crosslinking agent was added to the extrusion, and was cured by heating to provide a roller body.

Next, the roller body prepared as described above was attached to a shaft made of iron electroless-plated with nickel and having a diameter of 8 mm and length of 228 mm to provide a developing roller. The developing roller had a hardness (JIS-A) of about 54°.

### COMPARATIVE EXAMPLE 1

Example 1 was repeated to provide a roller body, except that the diazo yellow pigment was used in an amount of 35 parts by weight.

Next, the roller body was attached to a shaft made of iron electroless-plated with nickel and having a diameter of 8 mm and length of 228 mm to provide a developing roller. The developing roller had a hardness (JIS-A) of about 56°.

### COMPARATIVE EXAMPLE 2

Example 2 was repeated to provide a roller body, except that the phthalocyanine blue pigment was used in an amount of 35 parts by weight.

Next, the roller body was attached to a shaft made of iron electroless-plated with nickel and having a diameter of 8 mm and length of 228 mm to provide a developing roller. The developing roller had a hardness (JIS-A) of about 58°.

### COMPARATIVE EXAMPLE 3

Example 1 was repeated to provide a roller body, except that carbon black was used instead of the diazo yellow pigment.

Next, the roller body was attached to a shaft made of iron electroless-plated with nickel and having a diameter of 8 mm and length of 228 mm to provide a developing roller. The developing roller had a hardness (JIS-A) of about 48°.

### EXPERIMENTS

The developing rollers obtained from the above Examples 1 and 2, and Comparative Examples 1, 2 and 3 were used in a printing process.

First, each developing roller was evaluated for development with a toner comprising carbon black as a black pigment. Particularly, a background phenomenon of a photoreceptor, a charge-to-mass ration (QIM ratio) of a toner, and a roller hardness of the developing roller were measured and compared.

The results are set forth in the following Table 1.

TABLE 1

| Item | Background | Q/M of toner | Roller Hardness |
|---|---|---|---|
| Ex. 1 | 0.02 | 32 | 54 |
| Ex. 2 | 0.02 | 31 | 54 |
| Comp. Ex. 1 | 0.01 | 35 | 56 |
| Comp. Ex. 2 | 0.01 | 34 | 58 |
| Comp. Ex. 3 | 0.05 | 36 | 48 |

As can be seen from Table 1, developing rollers according to Examples 1 and 2 have a background index of 0.02, which indicates an insignificant degree of contamination in a non-image zone of the respective developing rollers. On the other hand, developing rollers according to Comparative Examples 1-3 have a background index of 0.01, which also indicates an insignificant degree of contamination in a non-image zone of the respective developing members.

Additionally, developing rollers according to Examples 1 and 2, and Comparative Examples 1 and 2 have a high Q/M ratio of a toner. This indicates that the rollers maintain frictional charging characteristics.

However, developing rollers according to Examples 1 and 2 have a roller hardness of 54° which is sufficient to maintain a desired elasticity. In contrast, developing rollers according to Comparative Examples 1 and 2 have a roller harness of 56° and 58°, respectively, which are each higher than a desired harness (55°), and thus have relatively poor elasticity as compared to the elasticity of the developing rollers of Examples 1 and 2.

Further, the developing roller according to Comparative Example 3, which includes carbon black in a similar manner to conventional developing rollers, has severe background contamination and a low Q/M ratio of a toner. This indicates that the toner is deteriorated in terms of a frictional charging capability.

As can be seen from the foregoing, a developing roller according to an embodiment of the present general inventive concept, which comprises a pigment having a polarity opposite to a polarity of a toner used in the developing roller, such as a pigment other than carbon black, maintains durability and heat resistance, and provides an image free from contamination in a non-image zone. Additionally, it is possible to improve processes for manufacturing the developing roller, because the developing roller according to an embodiment of the present general inventive concept may have the same color as the color of a toner by selecting a suitable pigment depending on the color of a toner to be developed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A developing roller useable with an electrophotographic image forming device using a toner to form an image, the developing roller comprising:
a central shaft; and
a roller body comprising a rubber-based elastic material and a pigment having an opposite polarity to the toner.

2. The developing roller as claimed in claim 1, wherein the pigment is present in the roller body in an amount of about 0.5 to about 30 parts by weight based on 100 parts by weight of the rubber-based elastic material.

3. The developing roller as claimed in claim 1, wherein the pigment is present in the roller body in an amount of about 1 to about 10 parts by weight based on 100 parts by weight of the rubber-based elastic material.

4. The developing roller as claimed in claim 1, wherein the rubber-based elastic material comprises at least one rubber selected from the group consisting of nitrile-butadiene rubber, epichlorohydrin rubber, chloroprene rubber, styrene-butadiene rubber, chlorosulfonated polyethylene rubber, and ethylene-propylene-diene terpolymer rubber.

5. The developing roller as claimed in claim 1, wherein the pigment comprises at least one compound selected from the group consisting of colorless inorganic pigments, colored inorganic pigments, and colored organic pigments.

6. The developing roller as claimed in claim 1, wherein the pigment comprises at least one compound selected from the group consisting of white inorganic pigments, black inorganic pigments, including yellow inorganic pigments, orange inorganic pigments, red inorganic pigments, purple inorganic pigments, blue inorganic pigments, green inorganic pigments, and phthalocyanine pigments, and diazo-based pigments.

7. The developing roller as claimed in claim 1, wherein the pigment comprises at least one compound selected from the group consisting of ZnO, TiO₂, lithopone (ZnS+BaSO₄) 2PbCO₃.Pb[OH]₂, FeO.FeO₃, PbCrO₄, FeO[OH], Fe₂O₃.H₂O, CdS, a mixed pigment of CdS with ZnS and TiO₂.NiO.Sb₂O₃, PbCrO₄.PbO, PbCrO₄.PbMoO₄.PbSO₄, Fe₂O₃, Pb3O4, a mixed pigment of CdS with CdSe, NH₄MnP₂O₇, Fe[NH₄]Fe[CN]6.xH₂O, Na6˜8Al₆Si₆O₂₄S_{2˜4}, CoO.Al₂O₃, Cu[CH₃CO₂]₂.3Cu[AsO₂]₂, phthalocyanine pigments, and diazo-based pigments.

8. The developing roller as claimed in claim 1, wherein the roller body further comprises a filler.

9. The developing roller as claimed in claim 8, wherein the filler comprises at lease one compound selected from the group consisting of CaCO₃, MgSiO₃, and Al₂(SiO₃)₄.

10. A method of manufacturing a developing roller useable with an electrophotographic image forming device, the method comprising:
blending a rubber-based elastic material, a pigment, and a filler;
aging and extruding the blend;
adding a crosslinking agent to the blend and curing the blend; and
cutting and processing the cured blend,
wherein the pigment comprises at least one compound selected from the group consisting of colorless inorganic pigments, colored inorganic pigments, and colored organic pigments.

11. A method of manufacturing a developing roller useable with an electrophotographic image forming device, the method comprising:
blending a rubber-based elastic material, a pigment, and a filler;
aging and extruding the blend;
adding a crosslinking agent to the blend and curing the blend; and
cutting and processing the cured blend,
wherein the pigment comprises at least one compound selected from the group consisting of white inorganic pigments, black inorganic pigments, including yellow inorganic pigments, orange inorganic pigments, red inorganic pigments, purple inorganic pigments, blue inorganic pigments, green inorganic pigments, and phthalocyanine pigments, and diazo-based pigments.

12. A method of manufacturing a developing roller useable with an electrophotographic image forming device, the method comprising:
blending a rubber-based elastic material, a pigment, and a filler;
aging and extruding the blend;
adding a crosslinking agent to the blend and curing the blend; and
cutting and processing the cured blend,
wherein the pigment comprises at least one compound selected from the group consisting of ZnO, TiO₂, lithopone (ZnS+BaSO₄) 2PbCO₃.Pb[OH]₂, FeO.FeO₃, PbCrO₄, FeO[OH], Fe₂O₃.H₂O, CdS, a mixed pigment of CdS with ZnS and TiO₂.NiO.Sb₂O₃, PbCrO₄.PbO, PbCrO₄.PbMoO₄.PbSO₄, Fe₂O₃, Pb3O₄, a mixed pigment of CdS with CdSe, NH₄MnP₂O₇, Fe[NH₄]Fe[CN]₆.xH₂O, Na_{6˜8}Al₆Si₆O₂₄S_{2˜4}, CoO.Al₂O₃, Cu[CH₃CO₂]₂.3Cu[AsO₂]₂, phthalocyanine pigments, and diazo-based pigments.

13. The method as claimed in claim 10, wherein the filler comprises at least one member selected from the group consisting of CaCO₃, MgSiO₃, and Al₂(SiO₃)₄.

14. The method as claimed in claim 10, wherein the rubber-based elastic material is at least one rubber selected from the group consisting of nitrile-butadiene rubber, epichlorohydrin rubber, chloroprene rubber, styrene-butadiene rubber, chlorosulfonated polyethylene rubber, and ethylene-propylene-diene terpolymer rubber.

15. The method as claimed in claim 10, wherein the pigment is used in an amount of about 0.5 to about 30 parts by weight based on 100 parts by weight of the rubber-based elastic material.

16. The method as claimed in claim 10, wherein the pigment is used in an amount of about 1 to about 10 parts by weight based on 100 parts by weight of the rubber-based elastic material.

17. A method of manufacturing a developing roller useable with an electrophotographic image forming device, the method comprising:
blending a rubber-based elastic material and a filler;
aging and extruding the blend;
adding a crosslinking agent to the blend and curing the blend;
mixing a pigment with a binder resin to form a pigment dispersion;
coating the cured blend with the pigment dispersion; and
cutting and processing the coated blend,
wherein the pigment comprises at least one compound selected from the group consisting of colorless inorganic pigments, colored inorganic pigments, and colored organic pigments.

18. The method as claimed in claim 17, wherein the filler comprises at least one compound selected from the group consisting of CaCO₃, MgSiO₃, and Al₂(SiO₃)₄.

19. The method as claimed in claim 17, wherein the rubber-based elastic material is at least one rubber selected from the group consisting of nitrile-butadiene rubber, epichlorohydrin rubber, chloroprene rubber, styrene-butadiene rubber, chlorosulfonated polyethylene rubber, and ethylene-propylene-diene terpolymer rubber.

20. The method as claimed in claim 17, wherein the pigment is used in an amount of about 0.5 to about 30 parts by weight based on 100 parts by weight of the rubber-based elastic material.

21. The method as claimed in claim 17, wherein the pigment is used in an amount of about 1 to about 10 parts by weight based on 100 parts by weight of the rubber-based elastic material.

22. An electrophotographic imaging device cartridge, comprising:
a toner unit comprising toner that includes a colorant having a first polarity; and
a developing roller, comprising:
a shaft; and
a body comprising a rubber-based material and at least one colorant having a second polarity that is different from the first polarity.

23. The cartridge as claimed in claim 22, wherein the body comprises a surface coating comprising a dispersion of the at least one colorant and a binder resin.

24. The cartridge as claimed in claim 22, wherein the body comprises a uniform dispersion of the rubber-based material and the at least one colorant.

25. The cartridge as claimed in claim 22, wherein a JIS-A hardness of the developing roller is in a range of about 20 degrees to about 55 degrees.

26. The cartridge as claimed in claim 22, wherein a JIS-A hardness of the developing roller is in a range of about 50 to about 54 degrees.

27. The cartridge as claimed in claim 22, wherein the at least one colorant is not carbon black.

28. The cartridge as claimed in claim 22, wherein a weight ratio of the at least one colorant to the rubber-based material is about 0.5:100 to about 30:100.
